(19) United States
(12) Patent Application Publication
(10) Pub. No.: US 2010/0176154 A1
(43) Pub. Date: Jul. 15, 2010

(54) Dispenser of Fine Granular Dry Materials With Light

(76) Inventor: Joseph Whitcombe, Davis, CA (US)

Correspondence Address: JOSEPH WHITCOMBE, 3500 ANDERSON ROAD, DAVIS, CA, 95616, US

(21) Appl. No.: 12/352,587

(22) Filed: Jan. 12, 2009

(51) Int. Cl. B65D 5/66; A47G 19/24; F21V 33/00

(52) U.S. Cl. 222/113; 362/96; 362/109; 222/192; 222/565

(57) ABSTRACT

A dispenser of granular dry materials with an integrated lighting element providing light optimized to permit users to visually monitor the flow and amount of material that is being or has been dispensed.

### CROSS-REFERENCE TO RELATED APPLICATIONS

| | | |
|---|---|---|
| 4,515,295 | May 1985 | Dougherty |
| 4,841,164 | June 1989 | Basso |
| 5,683,168 | November 1997 | Teig, et al. |
| 5,748,082 | May 1998 | Payne |
| 5,797,670 | August 1998 | Snoke, et al. |
| 6,711,466 | March 2004 | Abraham, et al. |
| 6,809,280 | October 2004 | Divigalpitiya, et al. |
| 7,014,336 | March 2006 | Ducharme, et al. |
| 7,303,300 | December 2007 | Dowling, et al. |
| 7,315,004 | January 2008 | Jarzynka, et al. |
| 7,410,197 | August 2008 | Edwards |

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to the field of manual dispensers fine granular material. The most relevant example of such dispensers is the salt shaker found on most dining tables. When people dispense granular materials from a dispenser, the lighting conditions often make it difficult or impossible to visually determine how much of the substance is being dispensed. This results in the user's inability to dispense the desired amount of the material based only on visual information.

In the case of a salt shaker, this problem manifests itself in situations where, due to factors related to the visibility of the salt being dispense (such as lighting conditions and the visual characteristics of table salt) the user of the salt shaker is unable to determine the amount of salt being sprinkled on food. This can result in over-applications, or under-applications, of salt.

The present state of the art in the field of technology related to dispensers of dry granular materials does not provide an integrated mechanism that specifically designed to enhance the ability of users of such items to visually determine them amount of the material being dispensed during the use of such dispensers. Currently, in order to enhance the user's ability to determine the amount of the material being dispensed, users are forced to either take steps to enhance the visual environment (such as turning on more lights, or moving the dispenser and the target of the dispenser to a position with better lighting),or to use non-visual means to determine the amount of granular material being dispensed (such as pouring the desired amount of the substance into a hand, where the sense of touch can determine the amount, and then manually sprinkling it).

### BRIEF SUMMARY OF THE INVENTION

The current invention integrates a dispenser of dry granular materials with a light emitting device (e.g., a light bulb or LED) and power source (e.g., a battery), with the light emitting component of the device specifically configured so as to enhance the visual environment in the spatial areas and surface necessary to allow the user to visually monitor, and thus manually control, the amount and flow of the dispensed materials, regardless of ambient lighting conditions. An extension of the invention further integrates a mechanism for automatically activating the light emitting mechanism when the dispenser is in use, and deactivating it when the dispenser is not in use (e.g., a motion-activate switch). A further extension of the invention involves integrating a light into the dispenser that radiates light at the optimal wavelength for visualizing the intended substance, based on the physical characteristics of the relevant substance. A further extension would incorporate a dimmer for the lighting element(s). A further extension would incorporate a light sensitive switch. A further extension would incorporate a multi-colored lighting element(s).

The invention address the shortcomings of the state of the technology related to dispensers of fine granular dry materials, as described the “Background Of The Invention” section, specifically, the fact that it is often difficult for people to see how much of such material they are applying or have applied. It does so by providing a lighting mechanism functionally and aesthetically integrated as a part of the dispenser, oriented and designed in a manner so as to provide sufficient light in all spatial areas necessary for the user to obtain sufficient visual information to determine, to a practically useful degree of precision, the amount of the substance being dispensed.

The immediate object of the invention is to allow users of dispensers of granular material to visually monitor and determine the amount of granular material being dispensed, when the visual environment would otherwise make such determinations difficult or impossible. One example of this object would be allowing the user of a salt shaker designed according to the specifications of the current invention to see, and thus monitor and control, the amount and flow of table salt being applied to food, when the visual environment (such as an environment with dim lighting) would otherwise make such activities imprecise, difficult, and/or impossible.

### BRIEF DESCRIPTION OF THE SEVERAL VIEWS OF THE DRAWING

FIG. 1 shows a side view of the invention in the embodiment of a bottom filled salt shaker with various walls and aspects rendered transparent. The essential aspect of the invention depicted is the light on top of the salt shaker 1, integrated in a manner such that, when the dispenser is turned sideways, the light will illuminate spatial areas necessary for the user to visually monitor the flow of granular material emitting from the dispensing orifices 11. The storage area 9 is where the material is stored. The hole in the bottom 4 is where the substance is loaded into to storage compartment 9 (this would be plugged with a stopper once filling is complete). Also depicted are positive 6 and negative 7 leads connecting a battery 2, a motion/tilt activated switch 3, and the light 1. A light sensitive switch or a touch activated switch 8 is also depicted. As shown the electronic components and their housings are located in a bottom compartment 5 separated from the storage compartment 9. The leads 6, 7 are connected between the lower compartment 5 and the light 1 through a space 10 in the outer wall of the device.

FIG. 2 is a bottom view of a manifestation of the current invention in the form of a design that incorporates all electronic components into a threaded screw-on cap that attaches to a separate container. As shown, the outer housing is not shown, thus revealing the components inside the device. Depicted is the lower (i.e. bottom) portion of a lighting element casing 13, attached to the battery 17 positive 16 and negative 18 leads. Also shown is a motion/tilt activated switch 12, a manual ON/OFF switch 14, a dimmer device 15, and a color control device 19 used to modify the color of the light being produced by the lighting element(s). The threads 21 of the cap, and the dispensing orifices 20 are also depicted.

FIG. 3 depicts a manifestation of the current invention in the form of a design that incorporates all electronic components into a screw-on cap that attaches to a separate container. This drawing shows the bottom of the “cap” in a non-cut-away view, and shows the relevant controls that would be accessible to the user during normal operation, including the manual ON/OFF switch 14, the dimmer control 15, and the light color control 19, as well as the threads 21 of the cap, and the dispensing orifices 20.

FIG. 4 depicts a manifestation of the current invention in the form of a design that incorporates all electronic components into a threaded screw-on cap that attaches to a separate container. This drawing depicts a version of the invention using one or more Light Emitting Diodes (LED) fixed in a casing 13, the bottom of which is depicted, that are individually or in combinations capable of producing multiple colors of light, as lighting elements. As shown, the dimmer control 24 and color selection control 23 for the LED, and the electronic components for these items, are contained in a single LED control unit 22, which is connected to the LED by a conduit containing multiple leads 25. Also depicted is the battery 17, the manual ON/OFF switch 14, a motion/tilt activated switch 12, and a positive 16 and negative 18 lead connecting the battery 17, the LED control unit 22, and the other components 12,14.

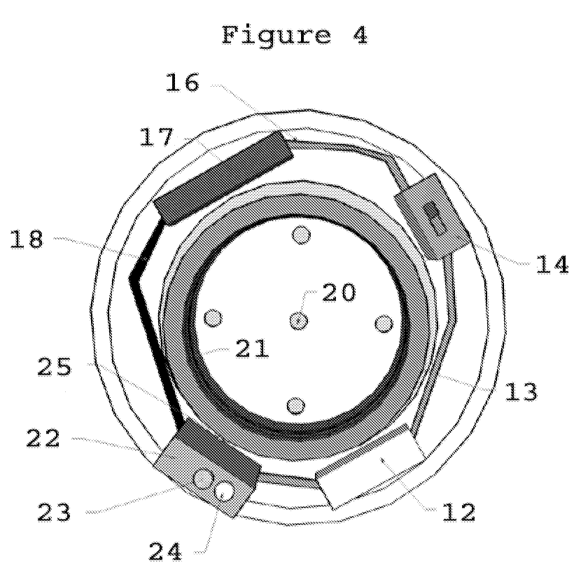

FIG. 5 depicts a manifestation of the current invention in the form of a design that incorporates all electronic components into a threaded screw-on cap that attaches to a separate container. This drawing shows the “cap” of the LED version of the invention depicted in FIG. 4 in a non-cut-away view, and shows the relevant controls that would be accessible to the user during normal operation, i.e. the dimmer control 24 and color selection control 23 for the LED, and the manual ON/OFF switch 14. The female threads 21 of the cap are also depicted.

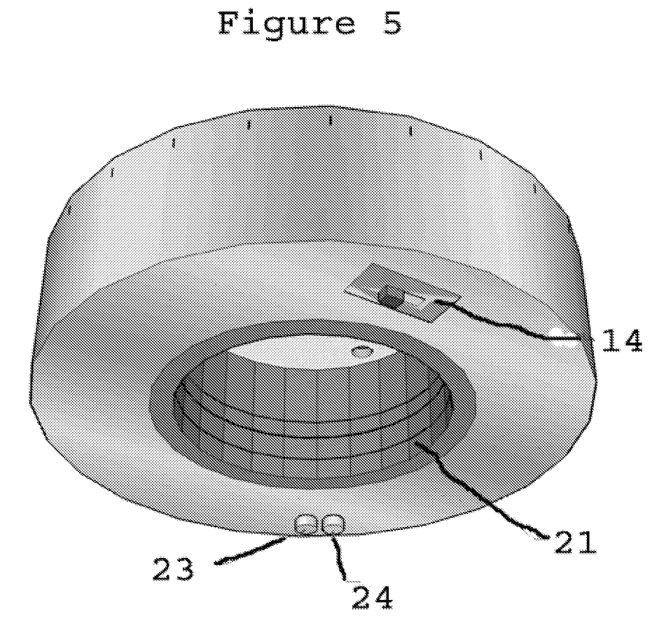

FIG. 6 depicts a top view of the “cap” manifestation, including the outer casing 27, the illuminant side of the lighting element 26, and the dispensing orifices 20.

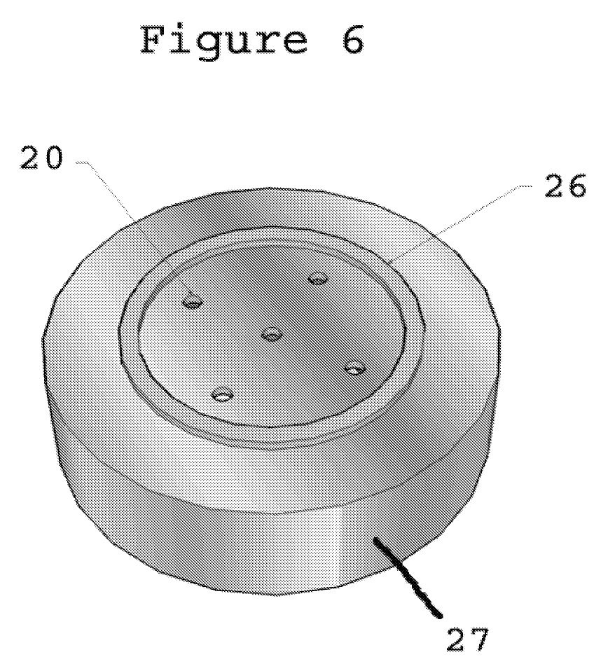

FIG. 7 depicts the container portion of the “cap” manifestation of the device, including the storage compartment 29 and the male threading 28.

FIG. 8 depicts one ideal use of the present invention, a bottom loaded salt shaker. As show, the lighting element is activated, illuminating an area that encompasses the areas 30 where the salt normally falls once it leaves the dispenser, and the surface area 32 where the salt will normally come to rest. The individual particles of the granular material 31 salt are illuminated.

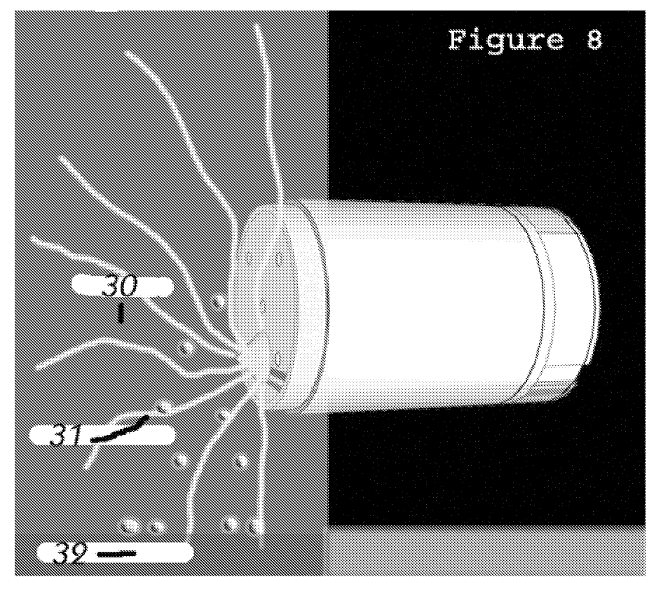

### DETAILED DESCRIPTION OF THE INVENTION

The preferred embodiment of the invention consists of a device that seamlessly integrates into a single form (1) a typical salt shaker, as found on most dining tables across the world, (2) a light oriented in a manner such that when activated, the light illuminates all areas necessary for the user to visually monitor the flow and quantity of salt that is being and has been dispensed while the device is in use, (3) a battery for powering the light, (4) a motion-activated or tilt-activated or touch-activated switch that activates the circuit, and thus turns on the light automatically when a user moves or picks up the device, and deactivates the circuit promptly when the device comes to rest or is released by the user, (5) a manual switch (i.e., an ON/OFF switch), for turning the device off, as for transport and such. And extension of the preferred embodiment would incorporate, in addition to the above, (6) a dimmer device to permit users to manually modify the intensity of the light emitted by the light/light array, and (7) a device to permit users to manually alter the color of the light being emitted by the light/light array.

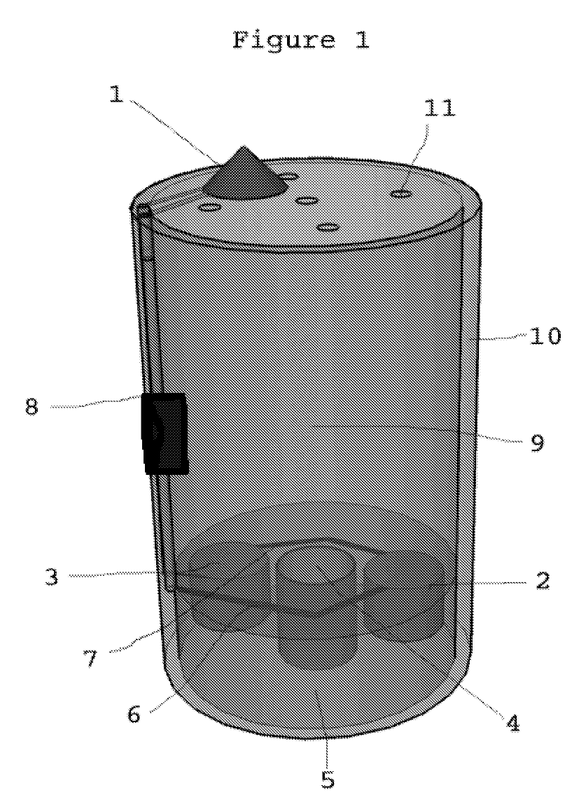

In one ideal manifestation, as shown in FIG. 1, the form of a traditional bottom-loaded salt shaker (including a storage compartment 9, loading orifice 4, and dispensing orifices 11) is modified, without interfering in any significant way with its aesthetic value and utility as a salt shaker, to include a compartment 5 which houses the battery 3, a motion/tilt activated switch 2, a light sensitive switch 8, and relevant wiring and housings for these devices. As shown, the light sensitive switch could also represent a touch sensitive switch 8. The bottom-loaded salt shaker is further modified such that the wall 10 of the device contains or has attached positive 7 and negative 3 lead wires leading to the circuit in the compartment, and to a light or lighting array at or near the “top” end of the device, i.e. the end with the small orifices 11 through which salt is dispensed during use of the device. It is also modified to have attached and integrated a light 1 situated, shaped, and oriented in such a manner as to illuminate all areas of space through which salt will normally “fall” during its application by the user 30, and all surface areas where the salt will “land” 32 (e.g., on food), thus illuminating the salt 31.

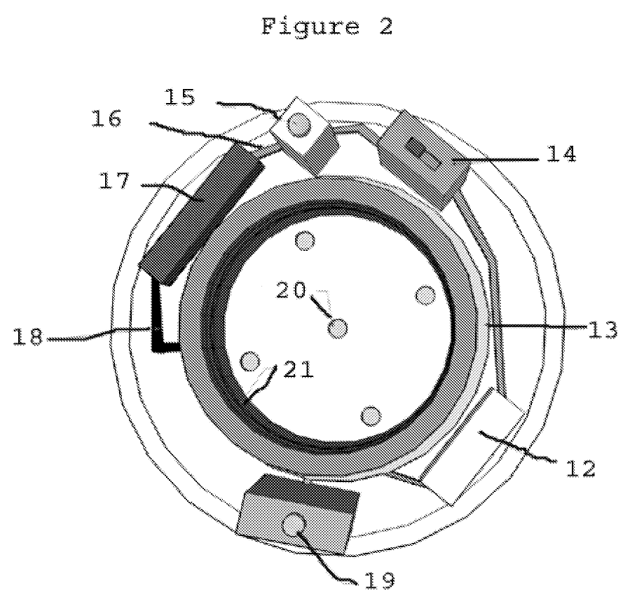

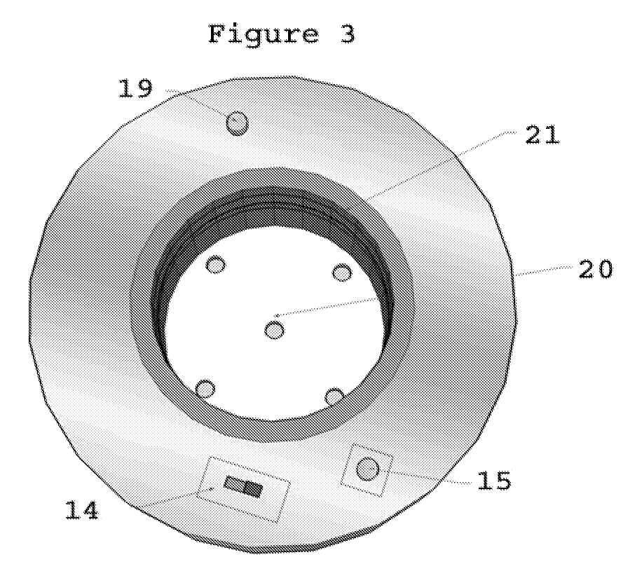

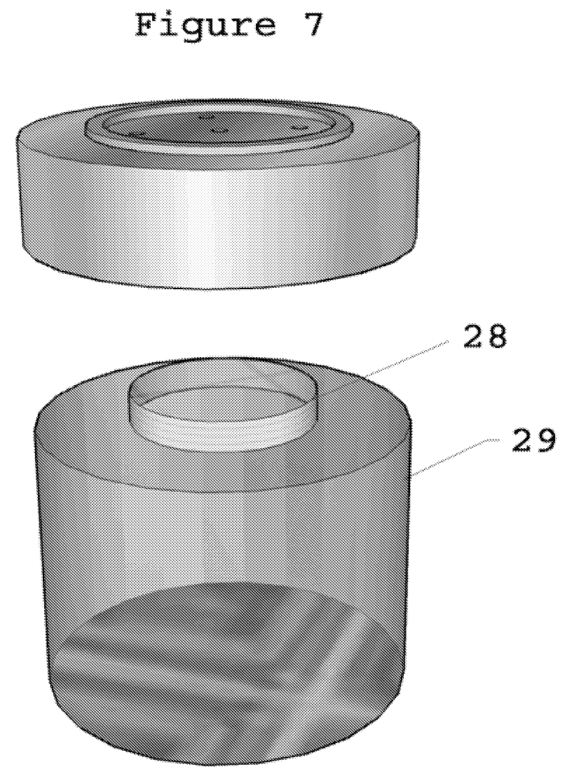

Another ideal manifestation takes the form of a two-piece salt shaker consisting of a “top” or “cap” that contains all electronic components and the lighting element 26, 13, and a “bottom” or “container” piece as shown in FIG. 7, which incorporates the “male” threads 28 for attaching the “cap”, and a container body 29. In this manifestation, as shown in FIGS. 2 and 3, the “cap” includes the parts of a typical salt-shaker cap including dispensing orifices 20 and female threads 21, and further incorporates a compartment that houses the battery 17, a motion/tilt/touch activated switch 12, and positive 16 and negative 18 leads connecting the battery to the electronic components and a lighting element 13, 26, along with a manual on/off switch 14. A light/light array 13, 26 is integrated into the top of the “cap” and is attached to the power source circuit by integrated leads 16, 18. The light/light array 13, 26 is integrated and situated, shaped, and oriented in such a manner as to illuminate spatial areas through which salt will normally “fall” during its application by the user 30, and surface areas where the salt will “land” 32 (e.g., on food), thus illuminated the salt 31.

FIGS. 2 and 3 depicts an extension of the invention in the “cap” manifestation that further incorporates a dimmer device 15, and a color control device 19 that would allow the user to control the color of the light emitted from the lighting element 13, 26.

An extension of the ideal manifestations of the device described above incorporates as the lighting element in the device a Light Emitting Diode (LED), or array of LEDs 26, 13 which may be single or multi-colored. This manifestation incorporates a control box 22 for the LED/LED array, which includes a dimmer control 24, and/or a control interface 24 that allows the color of the light being emitted from the LED/LED array to be altered and controlled 24 by the user.

This invention is different from previous technology in that no dispenser of granular dry material exists where a lighting element is integrated into the shaker in a manner that provides light in the areas necessary to visually monitor the salt as it is being dispensed. Likewise, no technology exists integrating this type of light-enhanced dispenser of granular dry material with an automatic switch, such as a motion activated switch, a tilt activated switch, or a touch-activated switch. Further, no current technology integrates these features with a lighting element and associated electronic controls that permit the user to select the intensity of the lighting being used to illuminate the granular dry material and target area. Further, no current technology integrates these features with a lighting element and associated electronic controls that permit the user to manually select the color of the light being emitted by the device.

1. A device designed for dispensing fine granular dry material (such as a salt shaker or pepper grinder), comprising:
a “container” portion, in which dry granular material or it its precursors is stored;
one or more dispensing orifices or openings, through which granular dry material exits the container during application and falls under the force of gravity toward the target area; and
a larger, sealable orifice for filling the container portion or the device other than through the dispensing orifice(s);
where such device further incorporates
one or more lighting element(s) integrated into the device and fixed, structured, placed, fastened and/or oriented relative to the dispensing orifices or openings in a manner to radiate light in spatial areas that such granular dry material may travel (normally, fall) during typical use of the dispenser for application of said material, such that the “falling” granular dry material is illuminated by the light;
a battery or other power supply; and
positive and negative leads directly or indirectly completing a circuit between the power supply and lighting element(s).

2. The device according to claim 1, wherein the device incorporates one or more compartments, separate from the container portion of the device, in which the power supply and electronic components are located.

3. The device, according claim 1 or claim 2, wherein the device contains a manual toggle switch for switching the circuit between the power source and the lighting element(s) “on” and “off”.

4. The device according to claim 1, claim 2, or claim 3, wherein the device integrates one or more switches or other devices or mechanisms for switching the circuit between the power source and the lighting element(s) “on” and “off”, wherein the switch is activated to complete the circuit (i.e. turn “on”) when the device is in or is about to be in use, and is activated to break the circuit (i.e. turn “off”) during those time periods when the device is not in use.

5. The device according to claim 4 wherein a switch or other device or mechanism for switching the circuit between the power source and the lighting element(s) “on” and “off” is a switch that is activated to complete the circuit (i.e. turn “on”) when the device is in motion, and is activated to break the circuit (i.e. turn “off”) during those time periods when the device is at rest.

6. The device according to 4, wherein a switch or other device or mechanism for switching the circuit between the power source and the lighting element(s) “on” and “off”, is a switch or other device that is activated to break the circuit (i.e. turn “off”) during those periods of time that the device is in a predetermined “default” position (e.g., in a “upright” position”), and is activated to complete the circuit (i.e. turn “on”) when the device is in any position other than the default position (i.e. is “tilted” in any direction).

7. The device according to claim 4 wherein a switch or other device or mechanism for switching the circuit between the power source and the lighting element(s) “on” and “off” is a switch or other mechanism that is activated to or naturally completes the circuit (i.e. turn “on”) when the device is contacted by an outside physical object (i.e. is “touched” or “held”), and is activated to break, or naturally breaks, the circuit (i.e., turn “off”) when contact with the outside physical object ceases.

8. The device according to claim 1, claim 2, claim 3, claim 4, claim 5, claim 6, or claim 7, wherein the device integrates a switch or other device or mechanism for switching the circuit between the power source and the lighting element(s) “on” and “off”, wherein the switch is activated to complete the circuit (i.e. turn “on”) when the intensity of ambient light surrounding the device is below a specified threshold, and is activated to break the circuit when the intensity of ambient light surrounding the device is above a specified threshold.

9. The device according to claim 1, claim 2, claim 3, claim 4, claim 5, claim 6, claim 7, or claim 8, wherein the lighting element(s) radiates light of a wavelength that, given the reflective properties of table salt, reflects light from table salt in a manner that approximately or precisely renders the table salt visible to a human of average eyesight to the maximum extent possible.

10. The device according to claim 1, claim 2, claim 3, claim 4, claim 5, claim 6, claim 7, or claim 8, wherein the lighting element(s) radiates light of a wavelength that, given the reflective properties of a particular the type of fine granular dry material that the device is intended to dispense, reflects light from that material in a manner that approximately or precisely renders the material visible to an average person to the maximum extent possible.

11. The device according to claim 1, claim 2, claim 3, claim 4, claim 5, claim 6, claim 7, claim 8, claim 9, or claim 10, wherein the device incorporates a light dimming device into the circuit between the power source and the lighting element, to allow the user to manually set the light intensity being radiated by the lighting element.

12. The device according to claim 1, claim 2, claim 3, claim 4, claim 5, claim 6, claim 7, claim 8, claim 9, claim 10, claim 11, or claim 12, wherein the device incorporates multiple lighting elements, at least some of which radiate different wavelength spectrums (i.e. colors) of light from the other(s).

13. The device according to claim 12 wherein the device incorporates a control apparatus that permits the user to manually select or set the lights that are activated when the lighting function of the device is activated, thus choosing the color of the radiated light.

14. The device according to claim 1, claim 2, claim 3, claim 4, claim 5, claim 6, claim 7, claim 8, claim 9, claim 10, claim 11, or claim 12, wherein the device incorporates at least one lighting element that is capable of radiating different wavelength spectrums (i.e. colors) of light (the “multi-colored light”).

15. The device according to claim 14 wherein the device incorporates a control apparatus that permits the user to manually control the color of the light radiated by the multi-color light.

16. The device according to claim 12 or claim 13, wherein the lighting elements incorporated into the device are multiple light emitting diodes of differing colors.

18. The device according to claim 14 or 15, wherein the multi-colored light is a multi-color light emitting diode.

19. The device according to claim 1, claim 2, claim 3, claim 4, claim 5, claim 6, claim 7, claim 8, claim 9, claim 10, claim 11, claim 12, claim 13, claim 14, claim 15, claim 16, or claim 17, wherein the device incorporates a lighting element control apparatus connected to the power source by positive and negative leads, and in which the lighting element(s) are attached to the control apparatus by separate leads.

20. The device according to claim 1, claim 2, claim 3, claim 4, claim 5, claim 6, claim 7, claim 8, claim 9, claim 10, claim 11, claim 12, claim 13, claim 14, claim 15, claim 16, or claim 17, claim 18, or claim 19, wherein the device is a salt shaker, modified as disclosed.
